(19) United States
(12) Patent Application Publication
(10) Pub. No.: US 2010/0142979 A1
(43) Pub. Date: Jun. 10, 2010

(54) MOTOR CONTROL APPARATUS AND IMAGE FORMING APPARATUS

(75) Inventor: Satoshi Atarashi, Toride-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/634,523

(22) Filed: Dec. 9, 2009

(30) Foreign Application Priority Data
Dec. 10, 2008 (JP) 2008-314609

(51) Int. Cl. G03G 15/00

(52) U.S. Cl. 399/36

(57) ABSTRACT

An image forming apparatus which forms an image on a sheet by using an image bearing member, the image forming apparatus includes a motor configured to rotate the image bearing member, a speed detection unit configured to detect a rotation speed of the motor or the image bearing member, a feedback control unit configured to supply the motor with a PWM signal which is acquired by performing a pulse width modulation on a feedback control value which is based on a target rotation speed, the rotation speed detected by the speed detection unit, and a feedback gain, and a gain updating unit configured to sample the PWM signal output from the feedback control unit during the image bearing member is in a steady rotation for an image forming operation and update the feedback gain based on the sampled PWM signal.

### BACKGROUND OF THE INVENTION

1. Field of the Invention

The present invention relates to a motor control apparatus which performs feedback control on a motor and an image forming apparatus provided therein.

2. Description of the Related Art

An electrophotographic type image forming apparatus such as a copying machine and a printer forms an electrostatic latent image by exposing a photosensitive drum, and then forms a toner image by developing the electrostatic latent image with charged toner. After the toner image is transferred onto an intermediate transfer member, the toner image is transferred onto a recording sheet to form the image thereon. In order for such an image forming apparatus to form a high quality image, an image bearing member such as a photosensitive drum and an intermediate transfer member needs to be rotated and driven accurately and stably.

In order for the image bearing member to control a driving operation accurately and stably, a drive control gain needs to be changed according to an amount of a load to the image bearing member. The load to the image bearing member includes a load caused by a member which contacts the image bearing member and by a bearing part of the image bearing member or a drive transmission gear. These loads vary according to aging of the members. If the load to the image bearing member is small and the drive control gain is large, the image bearing member cannot stably rotate. On the other hand, if the load to the image bearing member is large and the drive control gain is small, the image bearing member cannot accurately rotate.

As a method for changing a drive control gain according to an amount of a load to the image bearing member, Japanese Patent Application Laid-Open No. 09-117176 discusses a method for changing the drive control gain by detecting a current of a motor which drives the image bearing member to detect load fluctuation of the image bearing member.

However, the method discussed in Japanese Patent Application Laid-Open No. 09-117176 needs a current detection circuit for the motor to detect the load fluctuation of the image bearing member, thus costs may increase. Japanese Patent Application Laid-Open No. 2006-240212 discusses a method for detecting the load generated when a carriage is conveyed by detecting a duty rate of a pulse-width modulation (PWM) driving signal. However, the method discussed in Japanese Patent Application Laid-Open No. 2006-240212 detects the duty ratio by using an initial driving operation, in which the carriage is idled. Therefore, the load generated in a continuous operation cannot be detected. Thus the method discussed in Japanese Patent Application Laid-Open No. 2006-240212 cannot deal with changes due to aging of the image forming apparatus which is continuously operated for long hours. The present invention is directed to a motor control apparatus which can change a drive control gain according to an amount of a load of an image bearing member without providing additional hardware such as a current detection circuit.

### SUMMARY OF THE INVENTION

According to an aspect of the present invention, an image forming apparatus which forms an image on a sheet by using an image bearing member, said image forming apparatus includes a motor configured to rotate the image bearing member, a speed detection unit configured to detect a rotation speed of the motor or the image bearing member, a feedback control unit configured to supply the motor with a PWM signal which is acquired by performing a pulse width modulation on a feedback control value which is based on a target rotation speed, the rotation speed detected by the speed detection unit, and a feedback gain, and a gain updating unit configured to sample the PWM signal output from the feedback control unit during the image bearing member is in a steady rotation for an image forming operation and update the feedback gain based on the sampled PWM signal.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate exemplary embodiments of the invention and, together with the description, serve to explain the principles of the invention.

FIG. 1 is a cross-sectional view of an image forming apparatus which includes a motor control apparatus according to an exemplary embodiment of the present invention.

FIG. 2 is a control block diagram illustrating a configuration of a motor control apparatus.

FIG. 3 illustrates a PWM waveform generated by a PWM generation unit.

FIG. 4 illustrates a change of duty of the PWM waveform generated by the PWM generation unit.

FIG. 5 is a flowchart illustrating processing executed by a central processing unit when the motor control apparatus is in a gain adjustment mode.

### DESCRIPTION OF THE EMBODIMENTS

Various exemplary embodiments, features, and aspects of the invention will be described in detail below with reference to the drawings.

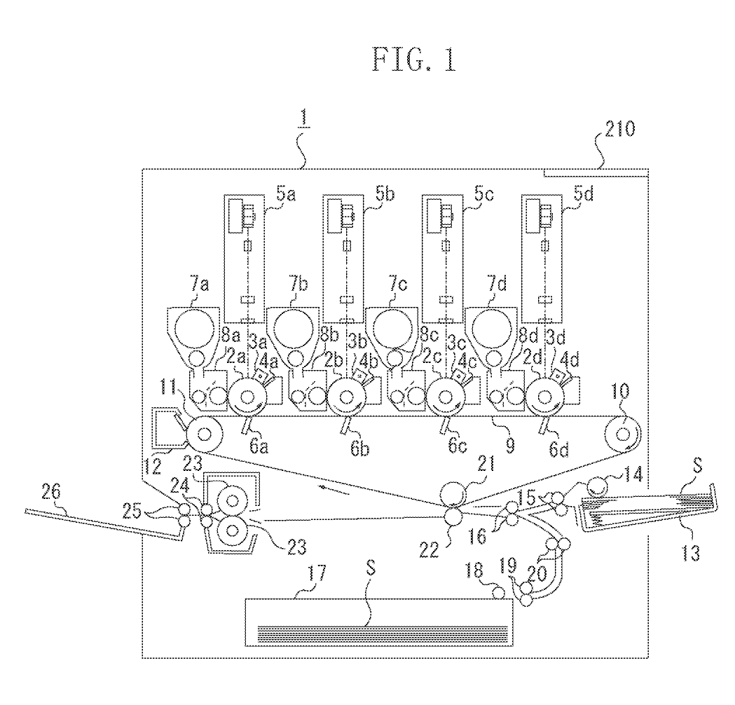

FIG. 1 is a cross-sectional view of an image forming apparatus including a motor control apparatus according to an exemplary embodiment of the present invention. The image forming apparatus is an electrophotographic type full color printer. An image forming apparatus 1 includes photosensitive drums 2a, 2b, 2c and 2d as first image bearing members or rotating members, electric chargers 3a, 3b, 3c, and 3d, cleaners 4a, 4b, 4c, and 4d, laser scanning units 5a, 5b, 5c, and 5d, and transfer blades 6a, 6b, 6c, and 6d. The image forming apparatus 1 further includes development units 7a, 7b, 7c, and 7d, development devices 8a, 8b, 8c, and 8d, an intermediate transfer belt 9 as a second image bearing member or a rotating member, rollers 10, 11, and 21 which support the intermediate transfer belt 9, and a cleaner 12.

The image forming apparatus 1 further includes a manual feeding tray 13 which stores recording sheets “S”, pickup rollers 14 and 15 which pick up the recording sheets “S”, a registration roller 16, a sheet cassette 17 which stores the recording sheets “S”, and pickup rollers 18 and 19, a vertical pass roller 20, a secondary transfer roller 22, a fixing roller 23, an internal sheet discharge roller 24, a sheet discharge roller 25, a sheet discharge tray 26, and an operation unit 210. The photosensitive drums 2a to 2d, the roller 10 (intermediate transfer belt 9), and the fixing roller 23 are rotated and driven by a direct current (DC) motor which will be described below.

In the image forming apparatus 1, an electrostatic latent image is formed on each of the photosensitive drums 2a to 2d for each color by respective laser scanning units 5a to 5d which have a semi-conductor laser as a light source. The electrostatic latent images are developed by respective development devices 8a to 8d.

The toner images of each color developed on respective photosensitive drum 2a to 2d are primary transferred onto the intermediate transfer belt 9. Four color toner images on the intermediate transfer belt 9 are transferred onto the recording sheet by the secondary transfer roller 22 and then fixed thereon by a thermal fixing device which includes the fixing roller 23 and the inside sheet discharge roller 24.

Along with this processing, the recording sheets are fed from the sheet cassette 17 or the manual feeding tray 13 and conveyed to the secondary transfer roller 22 by the registration roller 16 in a timing of registration.

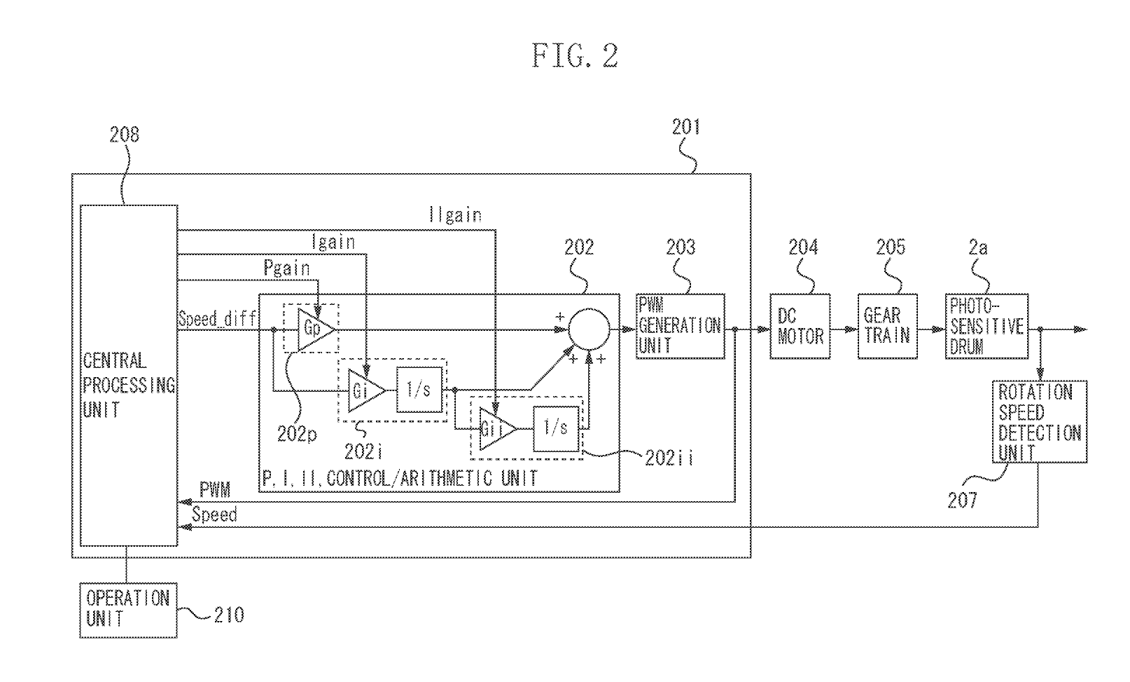

FIG. 2 is a control block diagram illustrating a configuration of the motor control apparatus. The control block of the motor control apparatus includes a control unit 201 which implements feedback control on the motor, a control/arithmetic unit 202, a pulse-width modulation (PWM) generation unit 203, a direct current (DC) motor 204, a gear train 205, a photosensitive drum 206, a rotation speed detection unit 207, and a central processing unit 208.

The rotation speed detection unit 207 detects a rotation speed, which is an angular speed or a peripheral speed, of the photosensitive drum 2a. The rotation speed detection unit 207 may detect the rotation speed of the photosensitive drum 2a by detecting a rotation speed of the DC motor 204. A rotation speed signal (Speed) detected by the rotation speed detection unit 207 is input to the central processing unit 208.

The central processing unit 208 subtracts the detected rotation speed from a target rotation speed to generate a speed difference signal (Speed_diff) and supplies the speed difference signal to the control/arithmetic unit 202. The control/arithmetic unit 202 which is a feedback arithmetic unit calculates a feedback control value based on the speed difference signal (Speed_diff) and supplies the feedback control value to the PWM generation unit 203.

The PWM generation unit 203 generates a PWM waveform (PWM signal) by performing a pulse width-modulation on the feedback control value calculated by the control/arithmetic unit 202. The PWM waveform generated by the PWM generation unit 203 is supplied to the DC motor 204 and also supplied to the central processing unit 208 as described below.

The DC motor 204 is specified for PWM control and can control a motor output by a PWM duty width. More specifically, the DC motor 204 performs PWM control on a voltage to be applied to a motor coil. The larger the PWM duty width is, the larger an average voltage is applied to the motor.

The larger the average voltage is applied to the motor coil, the larger torque is generated by the motor, or, the faster the rotation speed of the motor becomes. A rotational driving force generated by the DC motor 204 rotates the photosensitive drum 2a via the gear train 205. Only driving the photosensitive drum 2a will be described, however, other photosensitive drums 2b, 2c, and 2d and other devices to be driven are similarly driven.

The control/arithmetic unit 202 includes three modules, which are a proportion calculation unit 202p, an integral calculation unit 202i, and a double integral calculation unit 202ii. A feedback gain can be set for each calculation unit. The central processing unit 208 sets Pgain to the proportion calculation unit, Igain to the integral calculation unit, and IIgain to the double integral calculation unit. In an initial status, the central processing unit 208 sets Pgain_ini to the proportion calculation unit, Igain_ini to the integral calculation unit, and IIgain_ini to the double integral calculation unit.

The control/arithmetic unit 202 executes proportion calculation, integral calculation, and double integral calculation on the speed difference signal (Speed_diff) output from the central processing unit 208 and adds up each calculation result. The proportion calculation calculates a signal proportional to the speed difference signal, so that the proportion calculation means a speed correction signal. The integral calculation calculates a signal acquired by integrating the speed difference signal, and the integral calculation means a position correction signal. The double integral calculation calculates a signal acquired by double integrating the speed difference signal, and the double integral calculation means a position fluctuation correction signal.

The rotation speed signal (Speed) of the rotation speed detection unit 207 is repeatedly input to the central processing unit 208. The speed difference signal (Speed_diff) of the central processing unit 208 is repeatedly input to the control/arithmetic unit 202. The calculation result of the control/arithmetic unit 202 is repeatedly input to the PWM generation unit 203. Therefore, feedback control can be sequentially implemented on the photosensitive drum 2a in real time.

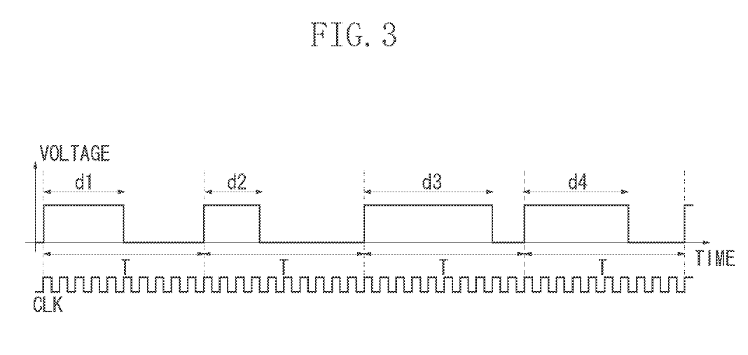

FIG. 3 illustrates a PWM waveform generated by the PWM generation unit 203. A period “T” of the PWM waveform is constant, and a control amount is expressed by a pulse width (duty ratio) in one period. The PWM waveform includes lengths on duty d1, d2, d3, and d4. The longer the length on duty in one period is, the larger an output of the DC motor 204 becomes. The PWM generation unit 203 generates the period and the pulse width based on a reference clock (CLK) of the central processing unit 208.

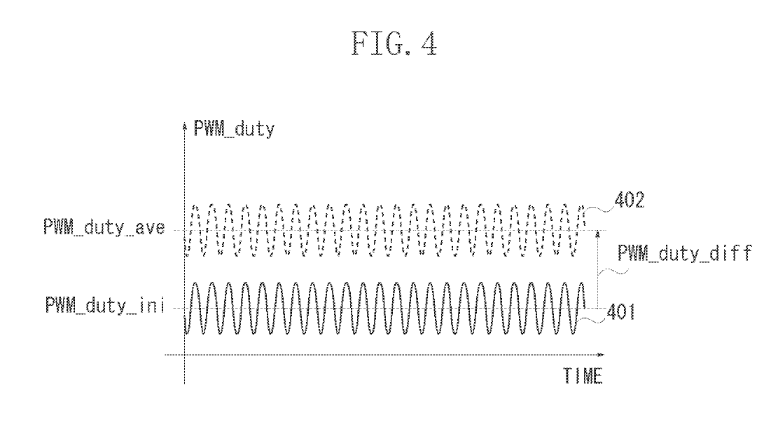

FIG. 4 illustrates a change in the duty of the PWM waveform generated by the PWM generation unit 203. A PWM waveform 401 in a solid line illustrates a change in an initial PWM duty from a point of a view of a change due to aging in a driving system of the photosensitive drum 2a. In the PWM waveform 401, a cyclic change of the PWM duty in a comparatively short period is caused by a motor output corresponding to a load fluctuation (torque fluctuation) due to an eccentricity (core deviation) of the gear train 205.

The PWM duty is sampled a plurality of times in a sampling period shorter than a period in which the PWM duty changes. An average value of the initial PWM duty (PWM_cuty_ini) is acquired by calculating an average of the sampled PWM duties. When the photosensitive drum 2a is driven at a constant rotation speed, the average value of the PWM duty is almost constant as long as the load to the photosensitive drum 2a does not change.

When the load to the photosensitive drum 2a is increased due to age-related deterioration of the driving system of the photosensitive drum 2a, the PWM waveform is shown as a PWM waveform 402 in a broken line in FIG. 4. Causes for increasing the load of the photosensitive drum 2a due to the age-related deterioration include wear of bearing and a decrease of lubricant of the driving transmission gear.

The average value of the PWM duty (PWM_duty_ave) can be acquired by sampling the PWM duty a plurality of times and calculating the average. A difference between PWM duty ini and PWM_duty_ave is defined as PWM_duty_diff.

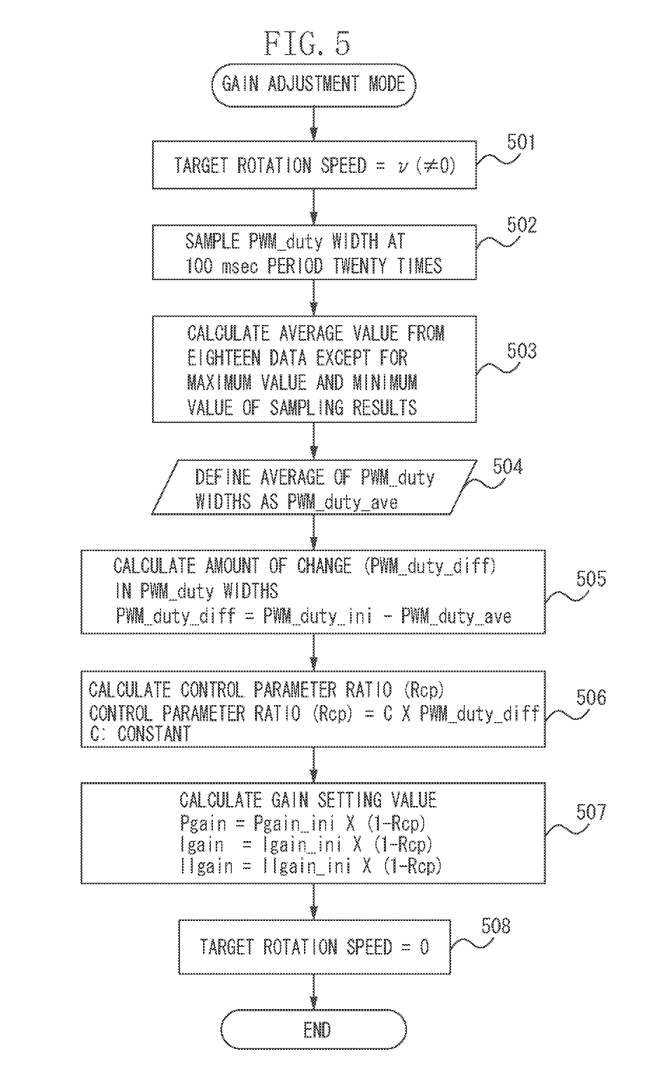

FIG. 5 is a flowchart illustrating processing executed by the central processing unit 208 in a gain adjustment mode to update a feedback gain of the motor control apparatus. In order to execute the gain adjustment mode, it is assumed that the similar processing as steps S502, S503, and S504, which will be described below, is performed to calculate the average value of the initial PWM duty (PWM_duty_ini) of the driving system of the photosensitive drum 2a and to store the average value in a non-volatile memory in the central processing unit 208. In step S501, the central processing unit 208 sets the target rotation speed to “v” (≠“0”) to rotate the DC motor 204 for the image forming operation.

In step S502, the central processing unit 208 samples the PWM_duty width of the PWM signal supplied to the DC motor 204 at 100 msec period over twenty times during the photosensitive drum 2a is in a steady rotation for the image forming operation. In step S503, the central processing unit 208 calculates the average value PWM_duty_ave from eighteen pieces of the sampling data except for maximum data and minimum data in the last twenty pieces thereof during the photosensitive drum 2a is in the steady rotation. That is, the twenty pieces of the sampling data right before the image forming operation ends are used for the gain adjustment mode. In step S504, the central processing unit 208 stores the average value in the memory thereof. The processing in steps S503 and S504 may be performed after or during the image forming operation.

In step S505, the central processing unit 208 calculates a change in the PWM duty width as follows. PWM_duty_diff=(PWM_duty_ini)−(PWM_duty_ave) In step S506, the central processing unit 208 calculates a control parameter ratio (Rcp)=C×(PWM_duty_diff). A constant “C” is determined according to characteristics of the employed driving system.

In step S507, the central processing unit 208 multiplies initial values of the feedback gains (Pgain_ini, Igain_ini, and IIgain_ini) by the control parameter ratio (Rcp) and acquires respective differences between the multiplied values and the initial values of the feedback gains (Pgain_ini, Igain_ini, and IIgain_ini). More specifically, the central processing unit 208 calculates each gain setting value as follows.

Pgain=(Pgain_ini)×(1−Rcp)

Igain=(Igain_ini)×(1−Rcp)

IIgain=(IIgain_ini)×(1−Rcp)

Then the central processing unit 208 updates the feedback gains (Pgain, Igain, and Ilgain) stored in the non-volatile memory thereof to the calculated feedback gains for the initiation of rotation of the photosensitive drum 2a. The update of the feedback gains is performed after the rotation of photosensitive drum 2a is stopped or decelerated, and before the rotation of photosensitive drum 2a is started. This is because the feedback gains (especially Igain) should not be updated in the middle of the feedback control of the photosensitive drum 2a in order to perform a stable feedback control. As described above, in steps S505, S506, and S507, the feedback gain is calculated by gain calculation based on the PWM waveform.

In step S508, the central processing unit 208 sets the target rotation speed to “0” to stop the DC motor 204.

When the image forming apparatus performs an image forming operation, the central processing unit 208 supplies the feedback gains (Pgain, Igain, and Ilgain) stored in the non-volatile memory thereof to the control/arithmetic unit 202. Thus, the output of the DC motor 204 is controlled according to the load fluctuation of the photosensitive drum 2a.

The above-described gain adjustment mode may be implemented at a period when the load fluctuation of the driving system such as the DC motor 204, the gear train 205, and the photosensitive drum 2a is taken account. More specifically, when an object to be driven by the motor, for example the photosensitive drum 2a, is exchanged, or when a number of sheets on which the image forming apparatus forms the images reaches a predetermined number (every predetermined number), the gain adjustment mode may be implemented.

When a serviceperson who exchanges the photosensitive drum 2a inputs an operation that he/she did via the operation unit 210, the central processing unit 208 recognizes that the photosensitive drum 2a is exchanged and then executes the gain adjust mode. The central processing unit 208 includes a rotation amount detection module for detecting a total rotation amount of the photosensitive drum 2a by accumulating and storing the output of the rotation speed detection unit 207.

When the detected total rotation amount reaches a predetermined rotation amount, the central processing unit 208 executes the gain adjustment mode. The central processing unit 208 may detect the total rotation amount of the photosensitive drum 2a by counting a number of pages of the recording sheets on which the image forming apparatus forms the images. Instead of performing the above-described gain adjustment mode when the photosensitive drum 2a is exchanged, the feedback gain may be initialized to a predetermined feedback gain when the photosensitive drum 2a is exchanged. This is because the difference of the loads between the new photosensitive drums is very small, and the feedback gain to be updated can be the predetermined feedback gain.

As described above, according to the present exemplary embodiment, since the load fluctuation of the object to be driven by the motor can be acquired without providing additional hardware, thus, costs of the apparatus can be reduced. Further, since a control calculation value is directly used when the average value of the load on the motor shaft is calculated, more accurate calculation results can be acquired by a simpler configuration than that of the current detection method.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-314609, filed Dec. 10, 2008, which is hereby incorporated by reference herein in its entirety.

What is claimed is:

1. An image forming apparatus which forms an image on a sheet by using an image bearing member, the image forming apparatus comprising:
a motor configured to rotate the image bearing member;
a speed detection unit configured to detect a rotation speed of the motor or the image bearing member;
a feedback control unit configured to supply the motor with a PWM signal which is acquired by performing a pulse width modulation on a feedback control value which is based on a target rotation speed, the rotation speed detected by the speed detection unit, and a feedback gain; and
a gain updating unit configured to sample the PWM signal output from the feedback control unit during the image bearing member is in a steady rotation for an image forming operation and update the feedback gain based on the sampled PWM signal.

2. The image forming apparatus according to claim 1, wherein the gain updating unit calculates the feedback gain based on a duty ratio of the PWM signal.

3. The image forming apparatus according to claim 2, wherein the gain updating unit calculates the feedback gain by multiplying an initial value of the feedback gain by a parameter based on the duty ratio of the PWM signal.

4. The image forming apparatus according to claim 2, wherein the gain updating unit samples a plurality of times the duty ratio of the PWM signal and calculates the feedback gain based on an average value of sampling data.

5. The image forming apparatus according to claim 4, wherein the gain updating unit calculates the average value by using the plurality of PWM signals sampled right before the image forming operation ends.

6. The image forming apparatus according to claim 1, the gain updating unit updates the feedback gain after the rotation of the image bearing member is stopped or decelerated.

7. The image forming apparatus according to claim 1, further comprising a recognition unit configured to recognize that the image bearing member is exchanged,
wherein the gain updating unit samples the PWM signal output from the PWM generation unit and updates the feedback gain to a predetermined feedback gain in response to the recognition unit recognizing that the rotating member is exchanged.
